(19) United States
(12) Patent Application Publication
(10) Pub. No.: US 2024/0420157 A1
(43) Pub. Date: Dec. 19, 2024

(54) METERING ABNORMALITY ANALYSIS METHOD AND APPARATUS, STORAGE MEDIUM, AND COMPUTER DEVICE

(71) Applicants: State Grid Chongqing Electric Power Company Marketing Service Center, Chongqing (CN); STATE GRID CORPORATION OF CHINA, Beijing (CN)

(72) Inventors: Jiaming ZHANG, Chongqing (CN); Ke ZHENG, Chongqing (CN); Ji XIAO, Chongqing (CN); Tao CHENG, Chongqing (CN); Hongyu XU, Chongqing (CN); Bo ZOU, Chongqing (CN); Shuwei WAN, Chongqing (CN); Xinke LV, Chongqing (CN); Bingling CHEN, Yubei District, Chongqing (CN); Shishun TAN, Chongqing (CN); Feng ZHOU, Chongqing (CN); Min HE, Chongqing (CN); Guangcheng XIE, Chongqing (CN); Ningtao LIU, Chongqing (CN)

(21) Appl. No.: 18/578,470

(22) PCT Filed: Oct. 8, 2023
(86) PCT No.: PCT/CN2023/123294

§ 371 Date: Jan. 11, 2024

(30) Foreign Application Priority Data
Jun. 16, 2023 (CN) 202310720828.3

(51) Int. Cl. G06Q 30/018; G06Q 50/06

(52) U.S. Cl. CPC G06Q 30/018; G06Q 50/06

(57) ABSTRACT

Provided are a metering abnormality analysis method and apparatus, a storage medium, and a computer device. The metering abnormality analysis method includes acquiring preliminary analysis data analyzed by a source-end system and determining at least one data filtering rule based on the preliminary analysis data (101); filtering the monitoring data of the source-end system based on the data filtering rule to obtain target metering abnormality data (102); comparing and analyzing the target metering abnormality data with preconfigured abnormal case data and determining at least one target case data from the abnormal case data (103); and performing multidimensional cluster analysis on the target metering abnormality data to obtain the aggregation level of the target metering abnormality data in multiple data dimensions and analyzing the cause of metering abnormality based on the target case data and the aggregation level (104).

### CROSS-REFERENCE TO RELATED APPLICATIONS

This is a National Stage Application, filed under 35 U.S.C. 371 based on International Patent Application No. PCT/CN2023/123294, filed on Oct. 8, 2023, which claims priority to Chinese Patent Application No. 202310720828.3 filed on Jun. 16, 2023, the disclosures of which are incorporated herein by reference in their entireties.

### TECHNICAL FIELD

The present application relates to the field of data processing and analysis technology, for example, a metering abnormality analysis method and apparatus, a storage medium, and a computer device.

### BACKGROUND

Metering abnormality is related to the fairness and impartiality of the electric power market and the customer perception of power supply services. Ensuring of the normal operation of an electric power metering device is a very important part of the entire electric power marketing environment. The abnormal causes of an electric power metering device are very complicated, including service problems, device problems, special working condition problems, and operation environment problems. If the abnormality of the electric power metering device is not eliminated clearly and not timely, a major accident may be caused.

In a metering abnormality analysis method, according to the degree of concern and importance, some data items are selected from a large amount of operation information of a metering device and used as key performance data, and then indicator calculation is performed based on the key performance data to determine the overall quality of the metering device and metering services based on indicator values. However, when the preceding analysis method is used, an analysis dimension is small, verification logic is simple, and the accuracy of research and judgment of problems caused by the joint action of multiple influence factors is low, which leads to the recurrence, spread, and transfer of metering abnormality problems and cannot implement the effect of reducing electric power operation and maintenance costs.

### SUMMARY

The present application provides a metering abnormality analysis method and apparatus, a storage medium, and a computer device.

In an aspect of the present application, a metering abnormality analysis method is provided. The method includes the steps below.

The preliminary analysis data analyzed by a source-end system is acquired. At least one data filtering rule is determined based on the preliminary analysis data.

The monitoring data of the source-end system is filtered based on the data filtering rule to obtain target metering abnormality data.

The target metering abnormality data is compared with preconfigured abnormal case data. At least one target case data is determined from the preconfigured abnormal case data.

Multidimensional cluster analysis is performed on the target metering abnormality data to obtain the aggregation level of the target metering abnormality data in multiple data dimensions. The cause of metering abnormality is determined based on the target case data and the aggregation level.

In another aspect of the present application, a metering abnormality analysis apparatus is provided. The apparatus includes a filtering rule determination module, a data acquisition module, a case determination module, and a cause analysis module.

The data acquisition module is configured to acquire the preliminary analysis data analyzed by the source-end system and determine at least one data filtering rule based on the preliminary analysis data.

The filtering rule determination module is configured to filter the monitoring data of the source-end system based on the data filtering rule to obtain the target metering abnormality data.

The case determination module is configured to compare the target metering abnormality data with preconfigured abnormal case data and determine at least one target case data from the preconfigured abnormal case data.

The cause analysis module is configured to perform multidimensional cluster analysis on the target metering abnormality data to obtain the aggregation level of the target metering abnormality data in multiple data dimensions and analyze the cause of metering abnormality based on the target case data and the aggregation level.

In another aspect of the present application, a storage medium is provided. The storage medium stores at least one executable instruction. The executable instruction enables a processor to execute the preceding metering abnormality analysis method.

In another aspect of the present application, a computer device is provided. The device includes a processor, a memory, a communication interface, and a communication bus. The processor, the memory, and the communication interface communicate with each other through the communication bus.

The memory is configured to store at least one executable instruction. The executable instruction enables the processor to execute the preceding metering abnormality analysis method.

### BRIEF DESCRIPTION OF DRAWINGS

FIG. 1 is a flowchart of a metering abnormality analysis method according to an embodiment of the present application.

FIG. 2 is a flowchart of another metering abnormality analysis method according to an embodiment of the present application.

FIG. 3 is a flowchart of another metering abnormality analysis method according to an embodiment of the present application.

FIG. 4 is a diagram illustrating a structure of a metering abnormality analysis apparatus according to an embodiment of the present application.

FIG. 5 is a diagram illustrating a structure of another metering abnormality analysis apparatus according to an embodiment of the present application.

FIG. 6 is a diagram illustrating a structure of a computer device according to an embodiment of the present application.

### DETAILED DESCRIPTION

Example embodiments of the present application are described below with reference to the drawings. Although the drawings illustrate the example embodiments of the present application, the present application may be implemented in various manners. These embodiments are provided for an understanding of the present application.

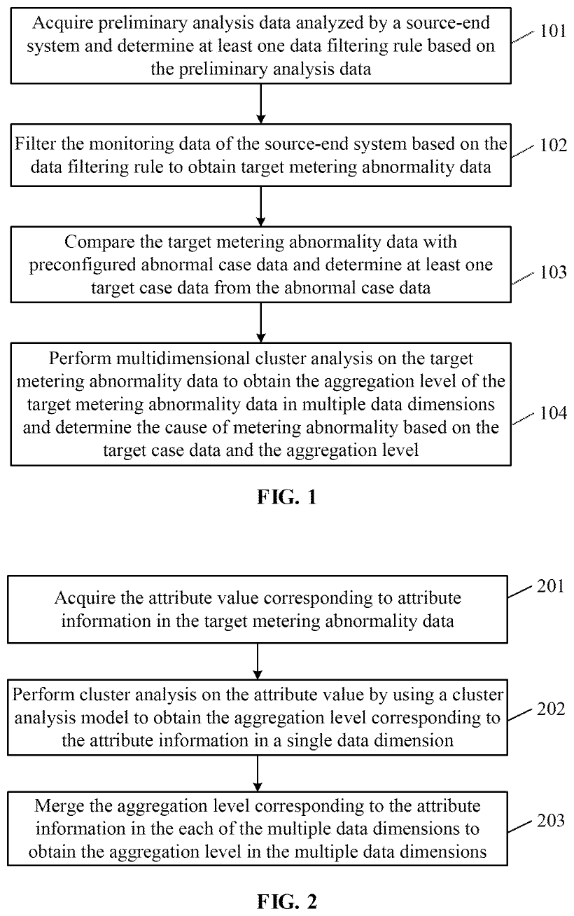

An embodiment of the present application provides a metering device analysis method. As shown in FIG. 1, the method includes the steps below.

In 101, the preliminary analysis data analyzed by a source-end system is acquired. At least one data filtering rule is determined based on the preliminary analysis data.

In this embodiment of the present application, the current execution end acquires the preliminary analysis data analyzed by the source-end system. The source-end system represents a system that has functions such as the online data monitoring of an electric power metering device, the misalignment monitoring of the electric power metering device, and the receipt of customer complaints. The source-end system may acquire the operation status data of all metering devices in the system in real time, may dispatch a work order based on a discrete function, and may find, in monthly indicator calculation, problems such as a high abnormality rate in a metering device and a decrease in a customer service satisfaction rate. The preliminary analysis data is used to represent the analysis data obtained through the system analysis function of the source-end system. For example, the preliminary analysis data may include at least one of nearly a hundred key indicators such as an acquisition success rate, the inaccuracy of an electric energy meter, the reverse flow of the electric energy meter, voltage phase failure, customer complaints, out-of-range line loss, and load overcapacity, and the sudden change in electric quantity. The type of the preliminary analysis data is not limited in this embodiment of the present application. After the current execution end acquires the preliminary analysis data, at least one data filtering rule is determined based on the preliminary analysis data.

Since the preliminary analysis data may reflect some abnormality problems of a metering device, that is, at least one key indicator has an indicator deviation problem. The key indicator having the indicator deviation problem is referred to as a key indicator deviation item. When the data filtering rule is determined, data filtering is performed based on the key indicator deviation item. For example, if the acquisition success rate of an electric energy meter is deviated, based on a normal acquisition success rate, the time period of the deviation of the acquisition success rate of the electric energy meter, the metering device corresponding to acquisition failure, and the detailed information related to the acquisition are determined. Optionally, the detailed information includes the archive information of an acquisition device (static information such as manufacturers, batches, types, and protocols), service information (the time, personnel, and conclusions of services such as operation time, operation and maintenance of the acquisition, on-site additional recording, on-site inspection tours, on-site checks, and assembly and disassembly), and operation information (dynamic information such as voltage curves, current curves, terminal addresses, clocks, and battery under-voltage events, power outage and power on events, cover opening records, and clock errors) that may affect the acquisition quality. The type of the detailed information is not limited in this embodiment of the present application. The current execution end performs data filtering on the detailed information related to the acquisition involved in the key indicator deviation item of the acquisition success rate of the preceding electric energy meter according to the time period of the deviation and the metering device corresponding to acquisition failure to determine the data filtering rule corresponding to the key indicator deviation item of the acquisition success rate of the electric energy meter. The determination method is not limited in this embodiment of the present application.

In 102, the monitoring data of the source-end system is filtered based on the data filtering rule to obtain target metering abnormality data.

In this embodiment of the present application, the current execution end filters the monitoring data of the source-end system based on the data filtering rule to obtain the target metering abnormality data. For example, the data filtering rule corresponding to the key indicator deviation item of the acquisition success rate of the electric energy meter in step 101 is used to perform the filtering operation, in the source-end system, the detailed information related to the acquisition corresponding to the energy meter 001 with failure acquisition during acquisition failure time period A, the detailed information related to the acquisition corresponding to the energy meter 003 with failure acquisition during acquisition failure time period B, the detailed information related to the acquisition corresponding to the energy meter 014 with failure acquisition during acquisition failure time period C, the detailed information related to the acquisition corresponding to the energy meter 036 with failure acquisition during acquisition failure time period D, and the detailed information related to the acquisition corresponding to the energy meter 102 with failure acquisition during acquisition failure time period E. For details about acquisition information, reference may be made to step 101.

In 103, the target metering abnormality data is compared with preconfigured abnormal case data. At least one target case data is determined from the abnormal case data. meter (static information such as manufacturers, batches, types, and specifications), service information (the time, personnel, and conclusions of services such as operation time, operation and maintenance of the acquisition, on-site additional recording, on-site inspection tours, on-site checks, and assembly and disassembly), and operation information (dynamic information such as voltage curves, current curves, terminal addresses, clocks, and battery under-voltage events, power outage and power on events, cover opening records, and clock errors) that may affect the acquisition quality of the electric energy meter. For another example, if the key indicator deviation item is the misalignment deviation of the electric energy meter, the target indicator association information that has a mapping relationship with the misalignment deviation of the electric energy meter may be the archive information of the electric energy meter (static information such as manufacturers, batches, types, specifications, accuracy levels, and verification errors), service information (the content, personnel, and recent status evaluation conclusions of previous on-site check errors, mounting time, mounting positions, operation environments, and recent on-site services), and operation information (voltages, currents, overload, phase deficiency, load imbalance, special power factors, and cover opening records) that may affect operation errors. The type of target indicator association information is not limited in this embodiment of the present application.

In this embodiment of the present application, the current execution end acquires the time period in which the key indicator deviation item is generated and determines the data filtering rule based on the time period in which the key indicator deviation item is generated and the target indicator association information. For example, when the key indicator deviation item is the deviation of the acquisition success rate of the electric energy meter, the target indicator association information of the corresponding electric energy meter in the time period in which the deviation of the acquisition success rate is generated is determined as the data filtering rule. When the key indicator deviation item is the misalignment deviation of the electric energy meter, the target indicator association information of the corresponding electric energy meter in the time period in which the misalignment deviation is generated is determined as the data filtering rule. The method for determining the data filtering rule based on the time period and the target indicator association information is not limited in this embodiment of the present application.

In an embodiment, to make the acquired monitoring data of the source-end system more accurate in terms of logic and data consistency and facilitate later data analysis, after the monitoring data of the source-end system is filtered based on the data filtering rule to obtain the target metering abnormality data, the method also includes the steps below.

Data logic verification processing is performed on the target metering abnormality data. Target metering abnormality data that does not conform to data logic in the target metering abnormality data is deleted. Moreover/Alternatively, data consistency verification processing is performed on the target metering abnormality data. Target metering abnormality data that does not conform to data consistency in the target metering abnormality data is deleted.

In this embodiment of the present application, the current execution end performs data logic verification processing on the target metering abnormality data and deletes target metering abnormality data that does not conform to data logic in the target metering abnormality data. In this manner, data is cleaned in terms of data logic. In other embodiment, the current execution end also performs data consistency verification processing on the target metering abnormality data and deletes target metering abnormality data that does not conform to data consistency in the target metering abnormality data. In this manner, data is cleaned in terms of data consistency.

In an embodiment, to support case retrieve and improve the reference ability of the case retrieve, the target metering abnormality data is compared and analyzed with the preconfigured abnormal case data. At least one target case data is determined from the abnormal case data in the manners below.

Case attribute information of the abnormal case data is acquired. The case attribute information is matched with to-be-matched attribute information of the target metering abnormality data to determine target attribute information from the to-be-matched attribute information. Similarity calculation is performed based on the attribute value corresponding to the target attribute information and the attribute value corresponding to the case attribute information. Abnormal case data corresponding to case attribute information whose similarity is greater than a threshold is determined as the target case data.

In this embodiment of the present application, the current execution end acquires the case attribute information of the abnormal case data, for example including the device name, the abnormal indicator, the abnormal duration, the abnormal impact scope of an abnormality metering device. The type of the case attribute information is not limited in this embodiment of the present application. The current execution end uses multiple attribute information of the target metering abnormality data as the to-be-matched attribute information and matches the case attribute information with the to-be-matched attribute information to determine the target attribute information from the to-be-matched attribute information. For example, from the plenty of attribute information of the target metering abnormality data, the successfully matched device name, the abnormal indicator, the abnormal duration, the abnormal impact scope of the abnormality metering device are determined as the target attribute information.

In this embodiment of the present application, the current execution end performs similarity calculation based on the attribute value corresponding to the target attribute information and the attribute value corresponding to the case attribute information. For example, the attribute value corresponding to the device name of the abnormality metering device is an electric energy meter, the attribute value corresponding to the abnormal indicator is an acquisition success rate value, the attribute value corresponding to the abnormal duration is duration (for example, 5 minutes, 1 hour, and 30 minutes), and the attribute value corresponding to the abnormal impact scope is the size of an impact region (for example, the number of abnormal electric energy meters and the number of regions with abnormal energy meters). The metering method of an attribute value is not limited in this embodiment of the present application. The current execution end determines the abnormal case data corresponding to the case attribute information whose similarity is greater than a similarity threshold as the target case data. The threshold is a preset value according to requirements.

In an embodiment, to perform deep analysis on the target metering abnormality data from multiple data dimensions, as shown in FIG. 2, multidimensional cluster analysis is performed on the target metering abnormality data to obtain the aggregation level of the target metering abnormality data in multiple data dimensions in the manners below.

In 201, the attribute value corresponding to single attribute information in the target metering abnormality data is acquired.

In 202, cluster analysis is performed on the attribute value by using a cluster analysis model to obtain an aggregation level in each of the multiple data dimensions.

In 203, the aggregation level in each of the multiple data dimensions is merged to obtain the aggregation level in the multiple data dimensions.

In this embodiment of the present application, the current execution end acquires the attribute value corresponding to the single attribute information in the target metering abnormality data and performs cluster analysis on the attribute value by using the cluster analysis model to obtain an aggregation level in a single data dimension. For example, the attribute information is a manufacturer, and the attribute value corresponding to the attribute information: {manufacturer A, manufacturer B, manufacturer A, manufacturer C, manufacturer B, . . . } is acquired to perform cluster analysis to obtain the aggregation level of manufacturer A, the aggregation level of manufacturer B, and the aggregation level of manufacturer C. For another example, the attribute information is a mounting position, and the attribute value corresponding to the attribute information: {position 1, position 3, position 1, position 1, position 2, position 3, position 3, . . . } is acquired to perform cluster analysis to obtain the aggregation level of position 1, the aggregation level of position 2, and the aggregation level of position 3.

The current execution end merges the obtained aggregation level in the single data dimension to obtain the aggregation level in the multiple data dimensions. The preceding aggregation level may be used for analyzing the batch abnormality of the metering device. For example, the misalignment rate deviation in the electric energy meter mainly occurs in the product of manufacturer A. The deviation of the acquisition success rate of the electric energy meter mainly occurs at mounting position 3.

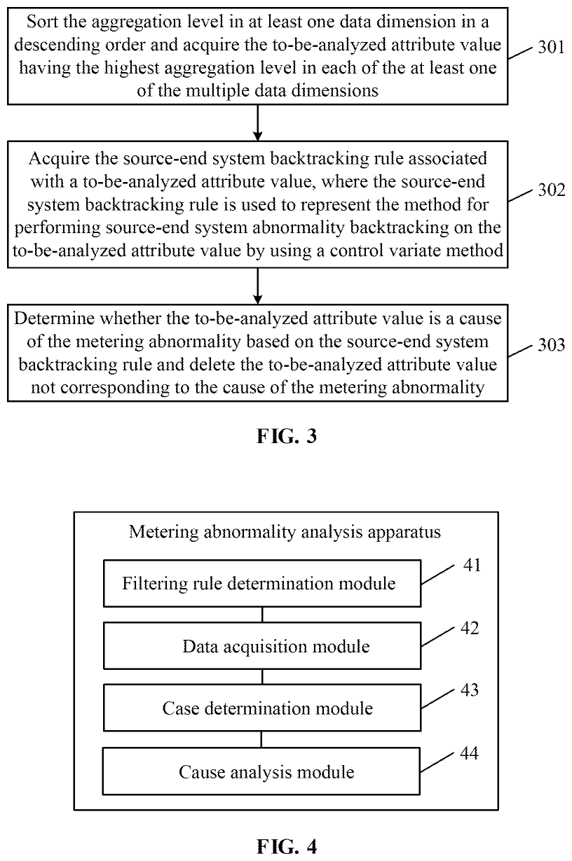

In an embodiment, to avoid a survivor error, that is, to avoid that analyzed abnormal cause does not conform to an actually abnormal situation and to improve the accuracy of metering abnormality analysis, as shown in FIG. 3, after multidimensional cluster analysis is performed on the target metering abnormality data to obtain the aggregation level of the target metering abnormality data in multiple data dimensions, the method also includes the steps below.

In 301, the aggregation level in at least one data dimension is sorted in a descending order. A to-be-analyzed attribute value having the highest aggregation level in each of the at least one data dimension is acquired.

In this embodiment of the present application, the current execution end sorts the aggregation level in at least one data dimension in a descending order, acquires an attribute value having the highest aggregation level in at least one data dimension, and uses the attribute value as the to-be-analyzed attribute value. For example, in the preceding embodiment, the aggregation level of electric energy meter manufacturer A, the aggregation level of electric energy meter manufacturer B, and the aggregation level of electric energy meter manufacturer C are 74, 8, and 11 respectively, manufacturer A may be determined as the to-be-analyzed attribute value. For another example, in the preceding embodiment, the aggregation level of mounting position 1 of the electric energy meter, the aggregation level of mounting position 2, and the aggregation level of mounting position 3 are 9, 7, and 77 respectively, mounting position 3 may be determined as the to-be-analyzed attribute value.

In this embodiment, the number of data dimensions to be sorted is not limited. In the case where the aggregation level in only one data dimension represents an aggregation level feature, only the aggregation level on the data dimension may be sorted. In the case where the aggregation level in multiple data dimensions represents an aggregation level feature, methods such as multi-condition constraints, weighted statistics, or condition analysis may be used to sort the aggregation level in the multiple data dimensions to form a combination scheme of the to-be-analyzed attribute value.

In 302, a source-end system backtracking rule associated with the to-be-analyzed attribute value is acquired.

In this embodiment of the present application, the current execution end acquires the source-end system backtracking rule associated with the to-be-analyzed attribute value. The source-end system backtracking rule is used to represent a method for performing source-end system abnormality backtracking on the to-be-analyzed attribute value by using a control variate method. For example, the actual cause of metering abnormality is the process problem of a mounter. However, due to the objective rule of purchase and supply, a batch of electric energy meters are manufactured by the same manufacturer, same specification, and same production batch, and even the mounting geographical positions are relatively close. The determined to-be-analyzed attribute value includes attribute values of the same manufacturer, the same specification, the same batch, and the same mounting position. Then, for example, the associated source-end system backtracking rule may be to acquire the monitoring data of the electric energy meter of the same manufacturer, the same production batch, and the same specification but mounted in different electric power units to determine whether there is abnormality or an increase in an abnormality rate; for another example, the associated source-end system backtracking rule may be to acquire the monitoring data of the electric energy meter of the same mounting position, the same manufacturer, and the same specification but of different mounting time to determine whether there is abnormality or an increase in an abnormality rate. The content of the source-end system backtracking rule is not limited in this embodiment of the present application.

In 303, whether the to-be-analyzed attribute value is a cause of the metering abnormality based on the source-end system backtracking rule is determined. A to-be-analyzed attribute value not corresponding to the cause of the metering abnormality is deleted.

In this embodiment of the present application, the current execution end determines whether the to-be-analyzed attribute value is the cause of the metering abnormality based on the source-end system backtracking rule and deletes the to-be-analyzed attribute value not corresponding to the cause of the metering abnormality. For example, the source-end system backtracking rule in step 302 is to in acquire the monitoring data of the electric energy meter of the same manufacturer, the same production batch, and the same specification but mounted in different electric power units to determine whether there is abnormality or an increase in an abnormality rate. It is determined that there is no abnormality in the electric energy meter mounted in different electric power units, and then the attribute value corresponding to the mounting position is deleted. The cause of metering abnormality of the electric energy meter due to the mounting position is eliminated, that is, the attribute value corresponding to the mounting position is not a cause of the metering abnormality. For example, the source-end system backtracking rule in step 302 is to acquire monitoring data of the electric energy meter of the same mounting position, the same manufacturer, and the same specification but of different mounting time to determine whether there is abnormality or an increase in an abnormality rate. It is determined that there is no abnormality in the electric energy meter of different mounting time, and then the attribute value corresponding to the mounting time is deleted. The cause of abnormality of the electric energy meter caused by the mounting time is eliminated, that is, the attribute value corresponding to the mounting time is not a cause of metering abnormality.

In an embodiment, to quickly and accurately send warning information to a related maintenance end, after the cause of metering abnormality is analyzed based on the target case data and the aggregation level, the method also includes the steps below.

Risk grading is performed on the metering abnormality according to a preset classification and grading strategy based on the cause of the metering abnormality to obtain a metering abnormality risk level. When the metering abnormality risk level exceeds a risk level threshold, risk warning information is generated by using a language model. The risk warning information is sent to the maintenance end through a preset risk warning interface.

In this embodiment of the present application, the current execution end performs risk

In this embodiment of the present application, the current execution end compares the target metering abnormality data with the preconfigured abnormal case data and determines at least one target case data from the preconfigured abnormal case data. Optionally, the preconfigured abnormal case data includes abnormality data in multiple data dimensions. Optionally, the current execution end performs comparison comprises that the current execution end performs comparison based on the similarity of the abnormality data in multiple data dimensions to determine at least one target case data.

In 104, multidimensional cluster analysis is performed on the target metering abnormality data to obtain the aggregation level of the target metering abnormality data in multiple data dimensions. The cause of metering abnormality is determined based on the target case data and the aggregation level.

In this embodiment of the present application, the current execution end performs multidimensional cluster analysis on the target metering abnormality data to obtain the aggregation level of the target metering abnormality data in multiple data dimensions. The multidimensional cluster analysis may use a statistical principle to perform volume statistics or may use a machine learning model to perform cluster analysis, such as fuzzy clustering, multiple regression, a decision tree, and a support vector machine. The method corresponding to multidimensional cluster analysis is not limited in this embodiment of the present application. The current execution end also analyzes the cause of metering abnormality based on the target case data and the aggregation level, for example, analyzes the correlation between the cause of metering abnormality in the target case data and the attribute value in the data dimension having a high aggregation level. This is not limited in this embodiment of the present application.

In an embodiment, to acquire data related to metering abnormality, filter out data not related to the metering abnormality, and determine at least one data filtering rule based on the preliminary analysis data, the method includes the steps below.

The mapping relationship between a key indicator and indicator association information is acquired. The target indicator association information corresponding to the key indicator deviation item is determined based on the mapping relationship. The time period in which the key indicator deviation item is generated is acquired. The data filtering rule is determined based on the time period and the target indicator association information.

In this embodiment of the present application, the current execution end acquires the mapping relationship between the key indicator and the indicator association information and determines the target indicator association information corresponding to the key indicator deviation item based on the mapping relationship. For example, if the key indicator deviation item is the deviation of acquisition success rate of the electric energy meter, the target indicator association information that has a mapping relationship with the deviation of the acquisition success rate of the electric energy meter may be the archive information of the electric energy grading on the metering abnormality according to the preset classification and grading strategy based on the cause of the metering abnormality to obtain the metering abnormality risk level. For example, the metering abnormality risk is divided into level 1, level 2, and level 3 according to factors such as a potential risk range, a hazard level, and an impact scope. The method for dividing metering abnormality risk level is not limited in this embodiment of the present application. The current execution end compares the metering abnormality risk level with a set risk level threshold. When the metering abnormality risk level exceeds the risk level threshold, the risk warning information is generated by using the language model. For example, when the metering abnormality risk level is level 3 and exceeds the risk level threshold, the risk warning information is generated. The set risk level threshold is not limited in this embodiment of the present application. The current execution end acquires the preset risk warning interface and sends the risk warning information to the related maintenance end through the risk warning interface. The risk warning interface is a network interface of a peripheral communication unit that completes data communication in a wired or wireless manner. The periphery communication unit is responsible for the necessary transcoding for the warning information and control instructions, transmits them to a system server, a monitoring screen, an acquisition terminal, an electric energy meter, an operation terminal, a handheld computer, the mobile phone of staff and other external devices in a reasonable communication manner, and ensures the quality of data transmission. When a transmission channel involves a public network or an external network device application, data desensitization or encryption processing should be performed as required.

In addition to the risk warning method in the preceding embodiment, risk warning may also be performed through a system prompt, a screen pop-up window, sending emails, and making phone calls. In addition to sending the warning information, the current execution end may also access risk information to the system for storage and temporary storage and include it in an abnormal case database after the cause of the problem is verified.

An embodiment of the present application provides a metering abnormality analysis method. Compared with the related art, in the present application, the preliminary analysis data analyzed by the source-end system is acquired. At least one data filtering rule is determined based on the preliminary analysis data. The monitoring data of the source-end system is filtered based on the data filtering rule to obtain the target metering abnormality data. The target metering abnormality data is compared and analyzed with the preconfigured abnormal case data. At least one target case data is determined from the abnormal case data. Multidimensional cluster analysis is performed on the target metering abnormality data to obtain the aggregation level of the target metering abnormality data in multiple data dimensions. The cause of metering abnormality is analyzed based on the target case data and the aggregation level. Thus, the cause of the electric power metering abnormality is analyzed. In the present application, the preliminary analysis data calculated through indicators in the related art is used for acquiring source data of more data dimensions, which not only expands an analysis dimension but also reduces the amount of data acquired from the source-end system. In the present application, the method for performing case matching and cluster analysis on data of the source-end system is used to improve the accuracy of research and judgment of a metering abnormality problem under the joint action of multiple factors.

As an implementation of the preceding method shown in FIG. 1, an embodiment of the present application provides a metering abnormality analysis apparatus. As shown in FIG. 4, the apparatus includes a filtering rule determination module 41, a data acquisition module 42, a case determination module 43, and a cause analysis module 44.

The data acquisition module 42 is configured to acquire the preliminary analysis data analyzed by the source-end system and determine at least one data filtering rule based on the preliminary analysis data. The filtering rule determination module 41 is configured to filter the monitoring data of the source-end system based on the data filtering rule to obtain the target metering abnormality data. The case determination module 43 is configured to compare the target metering abnormality data with preconfigured abnormal case data and determine at least one target case data from the preconfigured abnormal case data. The cause analysis module 44 is configured to perform multidimensional cluster analysis on the target metering abnormality data to obtain the aggregation level of the target metering abnormality data in multiple data dimensions and determine the cause of metering abnormality based on the target case data and the aggregation level.

The preliminary analysis data includes at least one key indicator deviation item. The data acquisition module 42 is also configured to acquire the mapping relationship between the key indicator and the indicator association information, determine the target indicator association information corresponding to the key indicator deviation item based on the mapping relationship, acquire the time period in which the key indicator deviation item is generated, and determine the data filtering rule based on the time period and the target indicator association information.

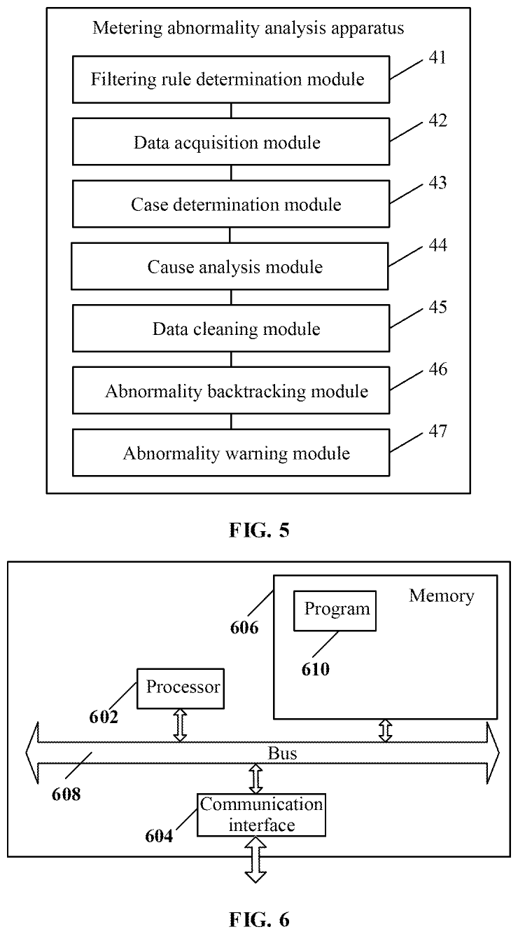

As shown in FIG. 5, the apparatus also includes a data cleaning module 45. The data cleaning module 45 is configured to perform data logic verification processing on the target metering abnormality data and delete target metering abnormality data that does not conform to data logic in the target metering abnormality data; and/or perform data consistency verification processing on the target metering abnormality data and delete target metering abnormality data that does not conform to data consistency in the target metering abnormality data.

The case determination module 43 is also configured to acquire the case attribute information of the abnormal case data, match the case attribute information with the to-be-matched attribute information of the target metering abnormality data, determine target attribute information from the to-be-matched attribute information, perform similarity calculation based on the attribute value corresponding to the target attribute information and the attribute value corresponding to the case attribute information, and determine abnormal case data corresponding to case attribute information whose similarity is greater than the threshold as the target case data.

The cause analysis module 44 is also configured to acquire the attribute value corresponding to single attribute information in the target metering abnormality data, perform cluster analysis on the attribute value by using the cluster analysis model to obtain the aggregation level corresponding to the attribute information in each of the multiple data dimensions, and merge the aggregation level corresponding to the attribute information in each of the multiple data dimensions to obtain the aggregation level in the multiple data dimensions.

As shown in FIG. 5, the apparatus also includes an abnormality backtracking module 46. The abnormality backtracking module 46 is configured to sort the aggregation level in at least one data dimension in a descending order, acquire the to-be-analyzed attribute value having the highest aggregation level in each of the at least one of the multiple data dimensions, and acquire the source-end system backtracking rule associated with the to-be-analyzed attribute value, where the source-end system backtracking rule is used to represent the method for performing source-end system abnormality backtracking on the to-be-analyzed attribute value by using the control variate method; and determine whether the to-be-analyzed attribute value is a cause of the metering abnormality based on the source-end system backtracking rule and delete the to-be-analyzed attribute value not corresponding to the cause of the metering abnormality.

As shown in FIG. 5, the apparatus also includes an abnormality warning module 47. The abnormality warning module 47 is configured to perform risk grading on the metering abnormality according to the preset classification and grading strategy based on the cause of the metering abnormality to obtain the metering abnormality risk level; in response to the metering abnormality risk level exceeding the risk level threshold, the abnormality warning module 47 is configure to generate the risk warning information by using the language model; and send the risk warning information to the maintenance end through the preset risk warning interface.

An embodiment of the present application provides a metering abnormality analysis apparatus. Compared with the related art, in the present application, the preliminary analysis data analyzed by the source-end system is acquired. At least one data filtering rule is determined based on the preliminary analysis data. The monitoring data of the source-end system is filtered based on the data filtering rule to obtain the target metering abnormality data. The target metering abnormality data is compared and analyzed with the preconfigured abnormal case data. At least one target case data is determined from the abnormal case data. Multidimensional cluster analysis is performed on the target metering abnormality data to obtain the aggregation level of the target metering abnormality data in multiple data dimensions. The cause of metering abnormality is analyzed based on the target case data and the aggregation level. Thus, the cause of the electric power metering abnormality is analyzed. In the present application, the preliminary analysis data calculated through indicators in the related art is used for acquiring source data of more data dimensions, which not only expands the analysis dimension but also reduces the amount of data acquired from the source-end system. In the present application, the method for performing case matching and cluster analysis on data of the source-end system is used to improve the accuracy of research and judgment of the metering abnormality problem under the joint action of multiple factors.

An embodiment of the present application provides a storage medium. The storage medium stores at least one executable instruction. The computer-executable instruction may execute the metering abnormality analysis method in any of the preceding method embodiments.

FIG. 6 is a diagram illustrating the structure of a computer device according to an embodiment of the present application. The implementation of the computer device is not limited in this embodiment of the present application.

As shown in FIG. 6, the computer device may include a processor 602, a communication interface 604, a memory 606, and a communication bus 608.

The processor 602, the communication interface 604, and the memory 606 communicate with each other through the communication bus 608.

The communication interface 604 is configured to communicate with network elements of other devices such as clients or other servers.

The processor 602 is configured to execute a program 610 and may execute the related steps of the preceding metering abnormality analysis method.

The program 610 may include a program code. The program code includes computer operation instructions.

The processor 602 may be a central processing unit (CPU), an application specific integrated circuit (ASIC), or one or more integrated circuits configured to implement embodiments of the present application. One or more processor included in the computer device may be the processor of the same type, such as one or more CPUs; or may be processors of different types, such as one or more CPUs and one or more ASICs.

The memory 606 is configured to store the program 610. The memory 606 may include a high-speed random access memory (RAM) and may also include a non-volatile memory, for example, at least one magnetic disk memory.

The program 610 may be configured to enable the processor 602 to execute the operations below.

The preliminary analysis data analyzed by the source-end system is acquired. At least one data filtering rule is determined based on the preliminary analysis data. The monitoring data of the source-end system is filtered based on the data filtering rule to obtain the target metering abnormality data. The target metering abnormality data is compared and analyzed with the preconfigured abnormal case data. At least one target case data is determined from the abnormal case data. Multidimensional cluster analysis is performed on the target metering abnormality data to obtain the aggregation level of the target metering abnormality data in multiple data dimensions.

The cause of metering abnormality is analyzed based on the target case data and the aggregation level.

Those skilled in the art should know that various modules or steps described above of the present application may be implemented by a universal computing device, the various modules or steps may be concentrated on a single computing device or distributed in a network composed of multiple computing devices. The various modules or steps may be implemented by program codes executable by the computing devices, so that they may be stored in a storage device for execution by the computing devices, and in some circumstances, the illustrated or described steps may be executed in sequences different from those described herein, or they may be made into various integrated circuit modules separately, or multiple modules or steps therein may be made into a single integrated circuit module for implementation. In this manner, the present application is not limited to any specific combination of hardware and software.

What is claimed is:

1. A metering abnormality analysis method, comprising:
acquiring preliminary analysis data analyzed by a source-end system and determining at least one data filtering rule based on the preliminary analysis data:
filtering monitoring data of the source-end system based on the at least one data filtering rule to obtain target metering abnormality data;
comparing the target metering abnormality data with preconfigured abnormal case data and determining at least one target case data from the preconfigured abnormal case data: and
performing multidimensional cluster analysis on the target metering abnormality data to obtain an aggregation level of the target metering abnormality data in a plurality of data dimensions and analyzing a cause of metering abnormality based on the at least one target case data and the aggregation level.

2. The method according to claim 1, wherein the preliminary analysis data comprises at least one key indicator deviation item; and
determining the at least one data filtering rule based on the preliminary analysis data comprises:
acquiring a mapping relationship between a key indicator and indicator association information and determining target indicator association information corresponding to the at least one key indicator deviation item based on the mapping relationship; and
acquiring a time period in which the at least one key indicator deviation item is generated and determining the at least one data filtering rule based on the time period and the target indicator association information.

3. The method according to claim 1, after filtering the monitoring data of the source-end system based on the at least one data filtering rule to obtain the target metering abnormality data, further comprising at least one of the following:
performing data logic verification processing on the target metering abnormality data and deleting target metering abnormality data that does not conform to data logic in the target metering abnormality data; or
performing data consistency verification processing on the target metering abnormality data and deleting target metering abnormality data that does not conform to data consistency in the target metering abnormality data.

4. The method according to claim 1, wherein comparing the target metering abnormality data with the preconfigured abnormal case data and determining the at least one target case data from the abnormal case data comprise:
acquiring case attribute information of the abnormal case data, matching the case attribute information with to-be-matched attribute information of the target metering abnormality data to determine target attribute information from the to-be-matched attribute information; and
performing similarity calculation based on an attribute value corresponding to the target attribute information and an attribute value corresponding to the case attribute information and determining abnormal case data corresponding to case attribute information whose similarity is greater than a threshold as the at least one target case data.

5. The method according to claim 1, wherein performing the multidimensional cluster analysis on the target metering abnormality data to obtain the aggregation level of the target metering abnormality data in the plurality of data dimensions comprises:
acquiring an attribute value corresponding to attribute information in the target metering abnormality data;
performing cluster analysis on the attribute value by using a cluster analysis model to obtain an aggregation level corresponding to the attribute information in each of the plurality of data dimensions; and
merging the aggregation level corresponding to the attribute information in the each of the plurality of data dimensions to obtain the aggregation level in the plurality of data dimensions.

6. The method according to claim 1, after performing the multidimensional cluster analysis on the target metering abnormality data to obtain the aggregation level of the target metering abnormality data in the plurality of data dimensions, further comprising:
sorting an aggregation level in at least one of the plurality of data dimensions in a descending order and acquiring a to-be-analyzed attribute value having a highest aggregation level in each of the at least one of the plurality of data dimensions:
acquiring a source-end system backtracking rule associated with the to-be-analyzed attribute value, wherein the source-end system backtracking rule is used to represent a method for performing source-end system abnormality backtracking on the to-be-analyzed attribute value by using a control variate method; and
determining whether the to-be-analyzed attribute value is a cause of the metering abnormality based on the source-end system backtracking rule and deleting a to-be-analyzed attribute value not corresponding to the cause of the metering abnormality.

7. The method according to any one of claims 1 to 6, after analyzing the cause of the metering abnormality based on the at least one target case data and the aggregation level, further comprising:
performing risk grading on the metering abnormality according to a preset classification and grading strategy based on the cause of the metering abnormality to obtain a metering abnormality risk level;
in response to the metering abnormality risk level exceeding a risk level threshold, generating risk warning information by using a language model; and
sending the risk warning information to a maintenance end through a preset risk warning interface.

8. A metering abnormality analysis apparatus, comprising:
a filtering rule determination module configured to acquire preliminary analysis data analyzed by a source-end system and determine at least one data filtering rule based on the preliminary analysis data;
a data acquisition module configured to filter monitoring data of the source-end system based on the at least one data filtering rule to obtain target metering abnormality data;
a case determination module configured to compare and analyze the target metering abnormality data with preconfigured abnormal case data and determine at least one target case data from the abnormal case data; and
a cause analysis module configured to perform multidimensional cluster analysis on the target metering abnormality data to obtain an aggregation level of the target metering abnormality data in a plurality of data dimensions and analyze a cause of metering abnormality based on the at least one target case data and the aggregation level.

9. A storage medium storing at least one executable instruction, wherein the at least one executable instruction executes the metering abnormality analysis method according to any one of claims 1 to 7.

10. A computer device, comprising a processor, a memory, a communication interface, and a communication bus, wherein the processor, the memory, and the communication interface communicate with each other through the communication bus; and
the memory is configured to store at least one executable instruction, and the at least one executable instruction enables the processor to execute the metering abnormality analysis method according to any one of claims 1 to 7.
